(19) United States
(12) Patent Application Publication
(10) Pub. No.: US 2010/0009716 A1
(43) Pub. Date: Jan. 14, 2010

(54) DUAL STANDBY PORTABLE TERMINAL AND COMMUNICATION METHOD THEREOF

(75) Inventors: Jae Myung LEE, Daegu Metropolitan City (KR); Chang Taek KANG, Gumi-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/494,795

(22) Filed: Jun. 30, 2009

(30) Foreign Application Priority Data
Jul. 11, 2008 (KR) 10-2008-0067631

(51) Int. Cl. H04B 1/38

(52) U.S. Cl. 455/558

(57) ABSTRACT

A dual standby portable terminal and a communication method thereof that can simultaneously connect to at least two communication networks are provided. The communication method includes operating a master Subscriber Identity Module (SIM),; initiating a call to a called portable terminal, determining if a first SIM switching process is required, switching the master SIM to a slave SIM if the first SIM switching process is required and operating the slave SIM and initiating the call with the called portable terminal. The portable terminals can make a call to each other through the same communication system or the same communication service provider's communication network, so that communication costs can be reduced.

### PRIORITY

This application claims the benefit under 35 U.S.C. §119(a) of a Korean patent application filed in the Korean Intellectual Property Office on Jul. 11, 2008 and assigned Serial No. 10-2008-0067631, the entire disclosure of which is hereby incorporated by reference.

### BACKGROUND OF THE INVENTION

1. Field of the Invention

The present invention relates to a portable terminal. More particularly, the present invention relates to a method and apparatus of a dual standby portable terminal that can simultaneously connect to at least two communication networks.

2. Description of the Related Art

As the popularity of portable terminals continues to increase and they are more widely used, manufacturers are developing them to provide a variety of additional functions beyond the simple communication function. In recent years, multi-mode portable terminals have appeared on the market, which can use two or more communication networks.

The conventional portable terminals that support one type of communication network can perform communication within only a corresponding communication network service area. In contrast, the multi-mode portable terminals can perform communication within two or more communication network service areas. For example, dual mode portable terminals can support a Code Division Multiple Access (CDMA) network and a Global System for Mobile communication (GSM) network, so that they can perform communication within both CDMA and GSM network service areas. Because they can be used in a plurality of different service areas, the dual mode portable terminals can be more widely used than the single mode portable terminals.

Since the conventional multi-mode portable terminals switch between networks in such a way that they enter an idle mode, are switched to a different network and then perform communication by operating their menu, they are complicated to operate and require time to switch between their modes.

In order to address these problems, unlike the multi-mode portable terminals, a dual standby portable terminal has been proposed. The dual standby portable terminal can simultaneously support two networks, for example, a CDMA network and a GSM network. This conventional dual standby portable terminal periodically requests and receives a preamble and/or a pilot channel signal from base stations for CDMA and GSM communication networks, respectively, even during the idle mode, and measures the channel states, such as Received Signal Strength Indication (RSSI), Carrier to Interference and Noise Ratio (CINR), Quality of Service (QoS), etc., so that it can simultaneously support two communication networks.

When this conventional dual standby portable terminal makes a call, it may perform the call using communication networks whose communication system and communication service providers differ from each other. For example, if a first portable terminal communicates with a first communication system/communication service provider, through its master Subscriber Identity Module (SIM) and a second portable terminal communicates with a second communication system/communication service provider, through its master SIM, the first and second portable terminals may perform communication through different communication systems/communication service providers. In this case, the communication costs may be higher than if the call were made using the same communication system/communication service provider. Therefore, a new method is required to perform communication through the same communication system/communication service provider.

### SUMMARY OF THE INVENTION

An aspect of the present invention is to address at least the above-mentioned problems and/or disadvantages and to provide at least the advantages described below. Accordingly, an aspect of the present invention is to provide a dual standby portable terminal and a communication method thereof that can make a call with a called portable terminal through a communication network that the called portable terminal is using.

Another aspect of the present invention is to provide a dual standby portable terminal and a communication method thereof that determines a communication network of a called portable terminal, before the dual portable terminal establishes a call to the called portable terminal, and performs a Subscriber Identity Module (SIM) switching process if its communication network differs from that of the called portable terminal, so that the portable terminals can make a call to each other.

Still another aspect of the present invention is to provide a dual standby portable terminal and a communication method thereof that performs a SIM switching process before the dual portable terminal establishes a call to the called portable terminal, if a server ascertains that the communication network of the dual standby portable terminal differs from that of a called portable terminal, so that the portable terminals can make a call to each other.

A further aspect of the present invention is to provide a dual standby portable terminal and a communication method thereof that determines previously stored information about a communication network, mapped to a called portable terminal, and performs a SIM switching process before the dual portable terminal establishes a call to the called portable terminal, if the communication network of the dual standby portable terminal differs from that of the called portable terminal, so that the portable terminals can make a call to each other.

In accordance with an aspect of the present invention, a communication method of a dual standby portable terminal that can simultaneously connect with at least two communication networks is provided. The communication method includes operating a master Subscriber Identity Module (SIM), initiating a call to a called portable terminal, determining if a first SIM switching process is required, switching the master SIM to a slave SIM if the first SIM switching process is required, and operating the slave SIM and initiating the call with the called portable terminal.

In accordance with another aspect of the present invention, a dual standby portable terminal is provided. The terminal includes two Subscriber Identity Modules (SIMs) for simultaneously connecting with at least two communication networks, a first communication unit for operating a master SIM and initiating a call with a called portable terminal, a second communication unit for operating a slave SIM and initiating a call with a called portable terminal, and a controller for switching the master SIM to the slave SIM if a first SIM switching process is required when the master SIM is operated and a call is initiated to the called portable terminal and for operating the slave SIM to make a call with the called portable terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a schematic view illustrating a communication system including dual standby portable terminals according to an exemplary embodiment of the present invention;

FIG. 2 is a schematic block diagram illustrating a dual standby portable terminal according to an exemplary embodiment of the present invention;

FIG. 3 is a flowchart describing a communication method of a dual standby portable terminal, according to an exemplary embodiment of the present invention;

FIG. 4 is a signal flowchart describing a communication method between communication system/communication service providers and dual standby portable terminals according to an exemplary embodiment of the present invention; and

FIG. 5 is a flowchart describing a communication method of a dual standby portable terminal, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In an exemplary embodiment of the present invention, a dual standby portable terminal refers to a portable terminal that can simultaneously connect to a communication network according to at least two communication systems or according to at least two communication service providers. For example, a dual standby portable terminal according to an exemplary embodiment of the present invention can be applied to portable terminals that can simultaneously connect to two communication networks whose communication systems are selected from a plurality of communication systems, such as Code Division Multiple Access (CDMA), Global System for Mobile Communication (GSM), Wideband Code Division Multiple Access (WCDMA) terminal, Wireless Broadband (WiBro), etc. In particular, in the Republic of Korea, a dual standby portable terminal according to an exemplary embodiment of the present invention refers to portable terminals that can simultaneously connect to two communication networks selected from a plurality of communication service providers, such as SK Telecom (SKT), Korea Telecom Freetel (KTF), LG Telecom (LGT), etc.

### Exemplary Embodiment 1

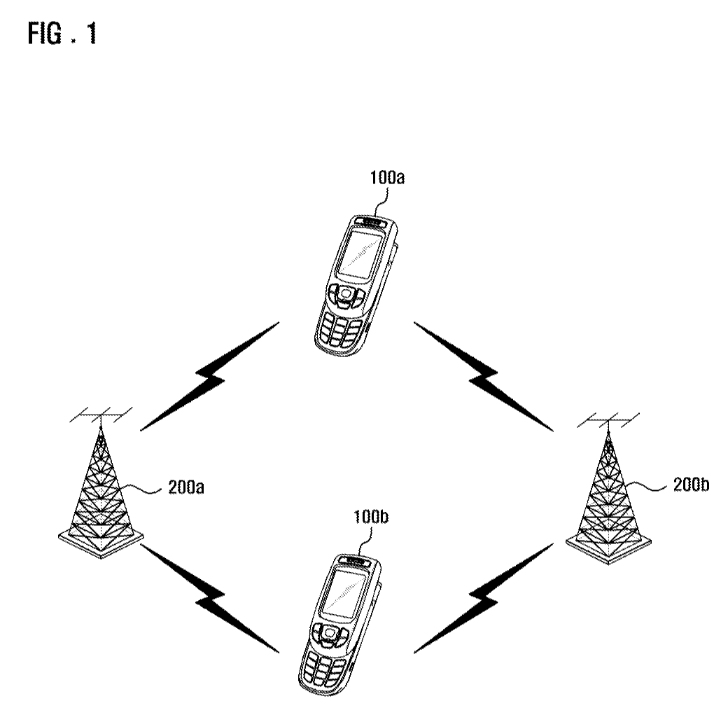

FIG. 1 is a schematic view illustrating a communication system including dual standby portable terminals according to an exemplary embodiment of the present invention.

Referring to FIG. 1, the communication system includes a plurality of dual standby portable terminals 100a and 100b, and the first and second communication networks 200a and 200b, respectively. The first communication network 200a refers to a base station of the first communication system/communication service provider and the second communication network refers to a base station of the second communication system/communication service provider 200b.

In the following description, a portable terminal initiating a call is referred to as the first portable terminal 100a and a portable terminal receiving the call is referred to as the second portable terminal 100b. The first and second portable terminals 100a and 100b may also be referred to as a portable terminal 100 as a general term.

The portable terminal 100 serves to provide a voice call service, a Short Message Service (SMS), a Multimedia Message Service (MMS), an Enhanced Message Service (EMS), etc. Furthermore, the portable terminal 100 may have an MP3 player to play back audio files, a camera to take photographs and the like.

In particular, the portable terminal 100 according to an exemplary embodiment of the present invention refers to a dual standby portable terminal. The portable terminal 100 can be connected to at least two communication networks whose communication systems differ from each other. In addition, the portable terminal 100 can be simultaneously connected to at least two communication networks whose communication service providers differ from each other. The portable terminal 100 may include at least one Subscriber Identity Module (SIM) in order to connect to at least two communication networks. For example, the portable terminal 100 can be implemented to include one SIM connected to two communication networks or two SIMs connected to two communication networks, respectively.

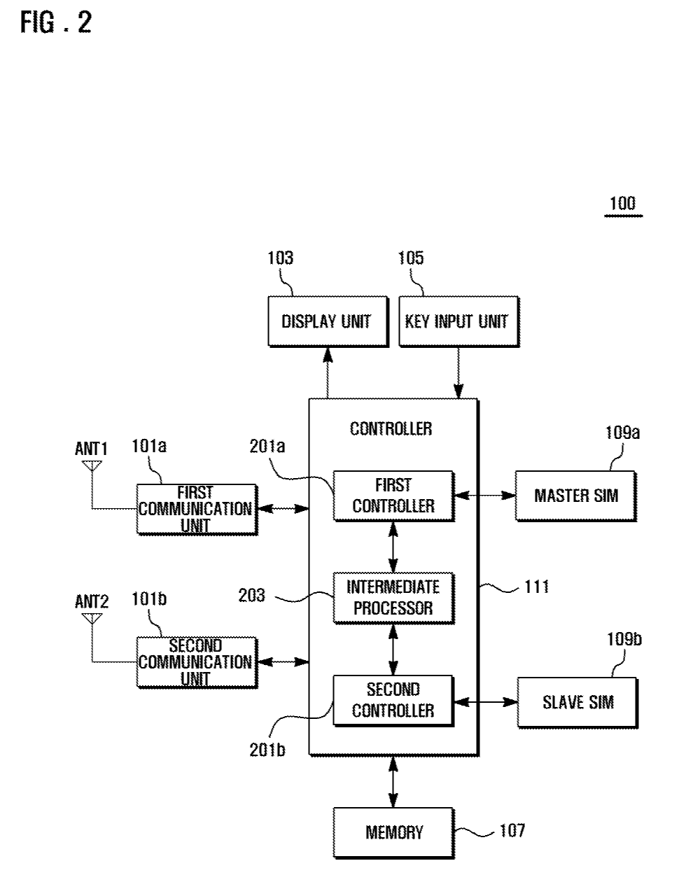

In the following description, exemplary embodiments of the present invention are described based on a portable terminal that includes two SIMs, i.e., a master SIM 109a and a slave SIM 109b as illustrated in FIG. 2. Although the exemplary embodiment also describes the second portable terminal 100b serving as the called portable terminal that includes two SIMs, it will be easily appreciated that the present invention is not so limited. For example, the second portable terminal 100b can be implemented not by a dual standby portable terminal but by a general portable terminal. Also, the function of the master SIM and slave SIM may be determined according to a user's setting or be set when the portable terminal is manufactured. Furthermore, the operation between the master SIM and the slave SIM may be switched by a controller.

The first portable terminal 100a operates a master SIM 109a and initiates a call to the second portable terminal 100b. The first portable terminal 100a initiates the call to the second portable terminal 100b through the first communication system/communication service provider 200a using the master SIM 109a. After that, if the first portable terminal 100a receives a SIM switching request signal from the first communication system/communication service provider 200a, where the SIM switching request signal indicates that the first communication system/communication service provider 200a differs from the communication system/communication service provider of the second portable terminal 100b, it performs a SIM switching process from the master SIM 109a to the slave SIM 109b. After that, the first portable terminal 100a operates the slave SIM 109b and then initiates a call to the second portable terminal 100b.

After the call is initiated with the second portable terminal 100b using the slave SIM 109b, if the communication systems/communication service providers are the same between the first and second portable terminals 100a and 100b, the first and the second portable terminals 100a and 100b establish the call to each other. However, if the communication systems/communication service providers are not the same, the first portable terminal 100a restores its function to the master SIM 109a and then establishes the call with the second portable terminal 100b. If the first portable terminal 100a ascertains that the SIM, operated when the original call is initiated, differs from a SIM operated while establishing the call with the second portable terminal 100b, it restores the SIM to its original state.

In the following description, a dual standby portable terminal according to an exemplary embodiment of the present invention is explained in more detail.

FIG. 2 is a schematic block diagram illustrating a dual standby portable terminal according to an exemplary embodiment of the present invention.

As illustrated in FIG. 2, the dual standby portable terminal 100 includes the first communication unit 101a, the second communication unit 101b, a display unit 103, a key input unit 105, a memory 107, a master SIM 109a, a slave SIM 109b, and a controller 111.

The first and second communication units 101a and 101b each serves to perform RF communication. They each include a Radio Frequency (RF) transmitter for up-converting the frequency of transmitted signals and amplifying the transmitted signals, and an RF receiver for low-noise amplifying of received RF signals and down-converting the frequency of the received RF signals. The first and second communication units 101a and 101b are coupled to antennas ANT1 and ANT2 for transmitting electromagnetic waves, respectively.

In an exemplary embodiment of the present invention, the first communication unit 101a refers to an RF communication unit that can be connected to a communication network of the first communication system/communication service provider 200a. The second communication unit 101b refers to an RF communication unit that can be connected to a communication network of the second communication system/communication service provider 200b. As an example, if the first communication system 200a employs GSM communication technology and the second communication system 200b uses CDMA technology, the first and second communication units 101a and 101b each perform RF transmission and reception through protocols according to GSM and CDMA networks, respectively. As another example, if the first communication service provider 200a is an SKT communication company operating in the Republic of Korea and the second communication service provider 200b is a KTF communication company, the first and second communication units 101a and 101b use their protocols and perform RF transmission and reception through the SKT and KTF networks, respectively.

The display unit 103 displays a variety of information related to states and operations of the dual standby portable terminal 100. For example, when the controller 111 initiates a call to the second portable terminal 100b, using a master SIM, and then switches to a slave SIM according to the requirements of a SIM switching process, the display unit 103 may display a pop-up message, according to the control of the controller 111, indicating that the slave SIM has been operated. That is, when the controller 111 operates the master SIM 109a to initiate a call and receives a SIM switching request signal since its communication system/communication service provider is not coincident with that of the second portable terminal 100b, the display unit 103 displays a pop-up message indicating that a slave SIM 109b should be operated. The display unit 103 may be implemented by various types of display devices, such as a Liquid Crystal Display (LCD), an Organic Light Emitting Diode (OLED), a Plasma Display Panel (PDP), etc.

The key input unit 105 receives a user's operating signals for controlling the operations of the dual standby portable terminal. In an exemplary embodiment of the present invention, the key input unit 105 receives a selection for making a call to the second portable terminal 100b, an input of an outgoing call signal, an input for a call termination signal, etc.

The memory 107 stores programs and information necessary for operations of the dual standby portable terminal 100. In an exemplary embodiment of the present invention, the memory 107 stores programs and data used for connection to the communication network of the first communication system/communication service provider 200a set as the first communication unit 101a and to the communication network of the second communication system/communication service provider 200b set as the first communication unit 101b. Although the exemplary embodiment of FIG. 2 is implemented with one memory 107, it should be understood that the present invention is not so limited. For example, the memory 107 may further include first and second memories that can store programs and data used for connection to communication networks set as the first and second communication units 101a and 101b. The first and second memories may each be controlled by first and second controllers 201a and 201b described below.

The master SIM 109a and slave SIM 109b each serve as a smart card that can support a dual standby mode. For example, the smart card can simultaneously support GSM and CDMA communication systems or SKT and KTF communication companies. If the master SIM 109a and slave SIM 109b each serves as a smart card that can support GSM and CDMA communication systems, they each can store data related to GSM and CDMA communication systems. The data includes subscriber information and authentication information for GSM and CDMA communication. In particular, the data includes recorded information related to RF communication, etc.

The data in the master SIM 109a and slave SIM 109b may be managed by a file system that is composed of a Master File (MF), a Dedicated File (DF), and an Elementary File (EF). The MF corresponds to a root file. The DF refers to a file corresponding to a sub-directory of the MF, or a file corresponding to a service that supports functions necessary for communication services, GSM, CDMA, etc. The DF has a plurality of EFs that store data used for respective services. The EF refers to all files for executing application files of each DF. The EF stores subscriber information and authentication information related to security, where the subscriber information may include subscriber's phone number, bill description, frequently used phone number, etc.

The master SIM 109a and slave SIM 109b each are inserted into card connecting units (not shown) serving as an interface and controlled by the first and second controllers 201a and 201b. The master SIM 109a and slave SIM 109b each receive and output signals, through the card connecting units, according to the control of the first and second controllers 201a and 201b. The card connecting units include slots into which the master SIM 109a and slave SIM 109b are detachably inserted. In particular, if the dual standby portable terminal 100 is implemented to include one SIM that can be connected to at least two communication networks, the card connecting unit also has one slot.

The controller 111 controls operations of elements in the dual standby portable terminal 100. In particular, the controller 111 controls the communication function of the dual standby portable terminal 100. When the controller 111 operates the master SIM 109a and initiates a call to the second portable terminal 100b, it determines whether to perform a SIM switching process. If the controller 111 receives a SIM switching request signal, a SIM switching process needs to be performed. The SIM switching request signal refers to a signal that notifies the first portable terminal 100a of a case where, when the first portable terminal 100a operates the master SIM 109a and initiates a call to the second portable terminal 100b through the first communication system/communication service provider 200a, it ascertains that the first communication system/communication service provider 200a is not the same as the communication system/communication service provider of the second portable terminal 100b.

When the controller 111 receives a SIM switching request signal, it operates the slave SIM 109b and initiates the call to the second portable terminal 100b. Using a notification function, the controller 111 can notify that the slave SIM 109b is operated. For example, the notification function may be a pop-up message, an alarm sound, a vibration, a lamp (with or without sound), etc.

If the controller 111 does not receive a SIM switching request signal when it operates the slave SIM 109b and initiates the call to the second portable terminal 100b, it establishes the call with the second portable terminal 100b. If the controller 111 receives a SIM switching request signal when it operates the slave SIM 109b and initiates the call, it restores the master SIM 109a set as the original master SIM and then establishes the call with the second portable terminal 100b.

The controller 111 includes first and second controllers 201a and 201b and an intermediate processor 203. As an example, when the master SIM 109a is set to a GSM communication system and the slave SIM 109b is set to a CDMA communication system, the first controller 201a controls communication using the GSM communication system and the second controller 201b controls communication using the CDMA communication system. The first and second controller 201a and 201b each may be implemented with an RF communication micro-controller chip. The first and second controllers 201a and 201b each may include a data processing module that includes a modem and a codec. The codec is composed of a data codec for processing a packet data, etc. and an audio codec for processing audio signals, such as a voice signal, etc. The first and second controllers 201a and 201b encode and modulate signals transmitted through the first and second communication units 101a and 101b. They also decode and demodulate the signals received through the first and second communication units 101a and 101b.

One of the first and second controllers 201a and 201b is set as a main controller, so that it can control blocks included in the dual standby portable terminal 100. This main controller can be set in such a way that one of the first and second controllers 201a and 201b is predefined to serve as a main controller. Alternatively, either of the first and second controllers 201a and 201b be selectively determined according to the occurrence of events.

The intermediate processor 203 serves as an interface allowing the first and second controllers 201a and 201b to communicate with each other.

In the following description, an exemplary communication method of a dual standby portable terminal is explained in more detail with reference to the drawings.

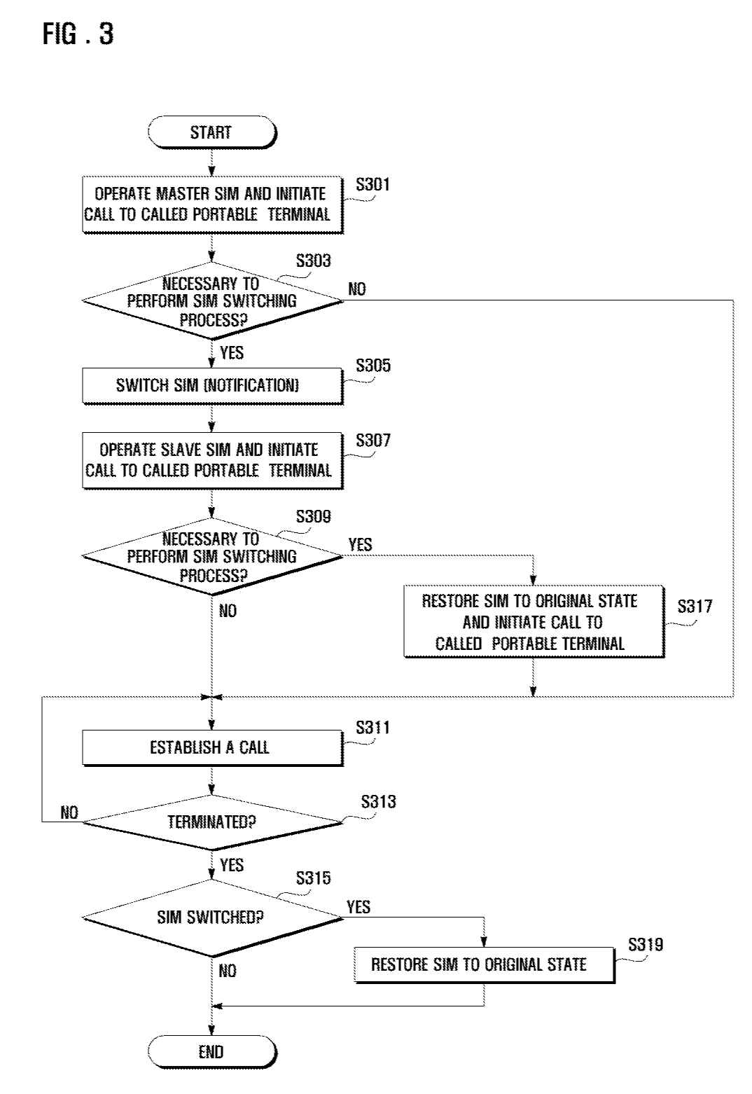

FIG. 3 is a flowchart describing a communication method of a dual standby portable terminal according to an exemplary embodiment of the present invention.

Referring to FIG. 3, the controller 111 of the first portable terminal 100a operates the master SIM 109a and initiates a call to the second portable terminal 100b, through the first communication system/communication service provider 200a, in step S301.

The controller 111 determines whether to perform a SIM switching process in step S303. In more detail, a server of the first communication system/communication service provider 200a receives a call request signal from the first portable terminal 100a and determines a communication system/communication service provider of the second portable terminal 100b. If the server of the communication system/communication service provider 200a does not support the second portable terminal 100b, it transmits an appropriate signal such as a notification signal to the first portable terminal 100a. In another exemplary implementation, the server of the communication system/communication service provider 200a transmits a SIM switching request signal to the first portable terminal 100a. If the controller 111 does not receive the signal at step S303, it proceeds with step S311.

In contrast, if the controller 111 receives the signal and ascertains that a SIM switching process is required at step S303, it performs a SIM switching process in step S305. The controller 111 performs a SIM switching process in such a way as to operate the slave SIM 109b instead of the master SIM 109a that was operated when the call was sent. In an exemplary embodiment, the controller 111 may display a pop-up message on the display unit 103, indicating that a SIM switching process is performed in such a way as to be switched to the slave SIM 109b. The controller 111 may also notify a user of the SIM switching process through one or more of a sound, a vibration and a visual indicator.

The controller 111 operates the slave SIM 109b and initiates the call to the second portable terminal 100b in step S307.

After that, the controller 111 determines whether to perform a SIM switching process again in step S309.

In an exemplary embodiment of the present invention, although the controller 111 ascertains that the communication system/communication service provider of the first portable terminal 100a differs from that of the second portable terminal 100b, performs a SIM switching process, and requests a call through the second communication system/communication service provider 200b, at steps S303 and S305, the second portable terminal 100b may be set to a communication system/communication service provider that differs from the second communication system/communication service provider. In an exemplary embodiment of the present invention, although the communication method is implemented in such a way that step S309 is performed after step S307, it should be understood that the present invention is not so limited. For example, in another exemplary embodiment, if a SIM switching process is performed at step S307, the controller 111 may operate the switched SIM and then establish the call in step S311.

If the controller 111 does not receive the SIM switching request signal and ascertains that a SIM switching process is not required at step S309, it establishes the call with the second portable terminal 100b in step S311. If the second communication system/communication service provider 200b, supported by the slave SIM 109b of the first portable terminal 100a, is the same as the communication system/communication service provider of the second portable terminal 100b, the first and second portable terminals 100a and 100b establish a call to each other.

After that, the controller 111 determines whether to terminate a call in step S313. If the controller 111 ascertains that a call is terminated at step S313, it further determines whether a SIM switching process is performed in step S315. The controller 111 determines whether a SIM, set when the original call is initiated, was switched to the other SIM during the call. In other words, the controller 111 determines whether the SIM operated at step S301 is the same as the SIM operated at step S311. If the master SIM 109a is operated at step S301 and the slave SIM 109b is operated at step S311, the controller 111 restores the SIM to the original state in step S319. The controller 111 restores the master SIM 109a to the original state at the time that a call is initiated. In contrast, if the controller 111 ascertains that a SIM switching process was not performed at step S315, it terminates a corresponding function.

Referring again to step S309, if the controller 111 receives a SIM switching request signal and ascertains that a SIM switching process is required, it restores the SIM to the original state and then initiates the call to the second portable terminal 100b in step S317. If the first and second communication systems/communication service providers 200a and 200b differ from the communication system/communication service provider of the second portable terminal 100b, the controller 111 restores the SIM to the master SIM that is set when the original call was initiated. After that, the controller 111 proceeds with step S311 as described above.

In the following description, an exemplary communication method between a communication system/communication service provider and a dual standby portable terminal is described.

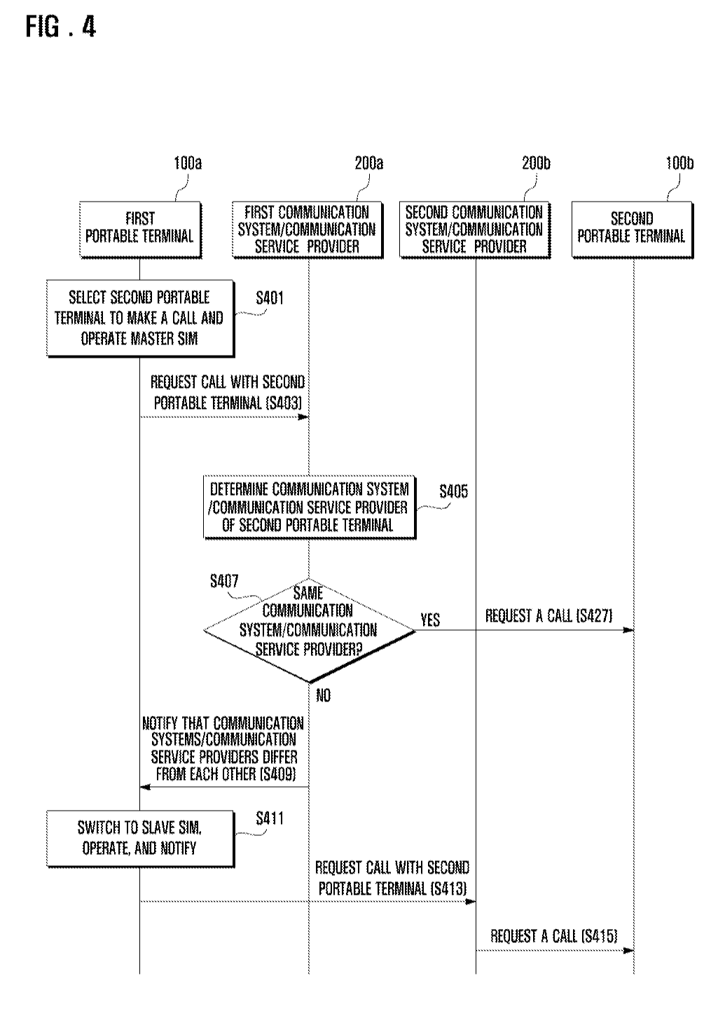

FIG. 4 is a signal flowchart describing a communication method between communication system/communication service providers and dual standby portable terminals according to an exemplary embodiment of the present invention.

Referring to FIG. 4, a first portable terminal 100a selects a second portable terminal 100b to make a call and operates a master SIM 109a in step S401.

The first portable terminal 100a requests a call with the second portable terminal 100b from a server of the first communication system/communication service provider 200a set as a master SIM 109a in step S403. The server of the first communication system/communication service provider 200a determines the communication system/communication service provider of the second portable terminal 100b in step S405. The server of the first communication system/communication service provider 200a determines whether it can support the second portable terminal 100b in step S407.

If the server of the first communication system/communication service provider 200a determines that it can support the communication system/communication service provider of the second portable terminal 100b at step S407, it requests a call from the second portable terminal 100b in step S427. After that, the first and second portable terminals 100a and 100b make a call therebetween (not illustrated).

In contrast, if the server of the first communication system/communication service provider 200a determines that it cannot support the communication system/communication service provider of the second portable terminal 100b at step S407, it notifies the first portable terminal 100a that its supporting communication system/communication service provider differs from that of the second portable terminal 100b in step S409.

Next, the first portable terminal 100a operates the slave SIM 109b and may notify that a SIM switching process is performed, via one or more of a pop-up message, a sound, a vibration and a visual indicator, in step S411.

The first portable terminal 100a requests a call with the second portable terminal 100b from a server of the second communication system/communication service provider 200b in step S413. The server of the second communication system/communication service provider 200b requests a call from the second portable terminal 100b in step S415. After that, the first and second portable terminals 100a and 100b make a call therebetween (not illustrated).

As described above with reference to FIG. 3, if the server of the second communication system/communication service provider 200b determines the communication system/communication service provider of the second portable terminal 100b, after step S413, and then ascertains that it can support the communication system/communication service provider of the second portable terminal 100b, it requests a call from the second portable terminal 100b, so that the first and second portable terminals 100a and 100b establish a call therebetween. Alternatively, if the server of the second communication system/communication service provider 200b ascertains that it can support a communication system/communication service provider that differs from that of the second portable terminal 100b, it notifies the first portable terminal 100a that its supporting communication system/communication service provider differs from that of the second portable terminal 100b. In that case, the first portable terminal 100a restores the SIM to the original state and then initiates a call to the second portable terminal 100b.

Although substantially the same process is shown at steps S403 and S413 in FIG. 4, the first portable terminal 100a does not perform the outgoing call initiation process twice. That is, step S413 is performed as a background process in that the first portable terminal 100a initiates an outgoing call process once to operate the SIM for the same communication system/communication service provider and then establishes a call with the second portable terminal 100b as described above.

Although the exemplary embodiment is implemented in such a way that the server of the communication system/communication service provider determines whether the communication systems/communication service providers of the first and second portable terminals are identical, it should be understood that the present invention is not limited thereto.

### Exemplary Embodiment 2

For sake of convenience, the description of elements in exemplary embodiment 2, which are substantially the same as or correspond to those of exemplary embodiment 1, will not be explained.

Exemplary embodiment 2 is substantially the same as exemplary embodiment 1 except for a method for determining whether a SIM switching process is required. That is, exemplary embodiment 1 is implemented in such a way that the server of communication system/communication service provider determines whether the communication system/communication service provider of the first portable terminal differs from that of the SIM in the second portable terminal and determines whether a SIM switching process is required. On the contrary, exemplary embodiment 2 is implemented in such a way that a portable terminal determines the communication system/communication service provider mapped to corresponding phone numbers stored in the memory and then determines whether a SIM switching process is required.

Referring to FIG. 1, the first portable terminal 100a operates the master SIM 109a and initiates a call to the second portable terminal 100b that is selected for a call. The first portable terminal 100a determines a communication network mapped to a phone number of the second portable terminal 100b, i.e., a communication system/communication service provider, and then determines whether the communication system/communication service provider is the same as the first communication system/communication service provider 200a set to the master SIM 109a. If the communication system/communication service provider differs from the first communication system/communication service provider 200a set to the master SIM 109a, or if the communication system/communication service provider mapped to the second portable terminal 100b is the second communication system/communication service provider 200b, the first portable terminal 100a performs a SIM switching process. After the first portable terminal 100a performs a SIM switching process to the slave SIM 109b, it operates the slave SIM 109b and initiates the call to the second portable terminal 100b.

If the master SIM 109a and slave SIM 109b in the first portable terminal 100a do not support the communication system/communication service provider mapped to and stored in the second portable terminal 100b, the first portable terminal 100a operates the master SIM and establishes the call with the second portable terminal.

Referring to FIG. 2, the key input unit 105 of the dual standby portable terminal 100 is used to select a phone number storing mode and to receive phone numbers and information about the communication system/communication service provider corresponding to the phone numbers.

The memory 107 may further include a phone book. The phone book stores phone numbers stored in a phone number storing mode, wherein the phone numbers are mapped with information about corresponding communication system/communication service provider.

When the controller 111 operates the master SIM 109a and initiates a call to the second portable terminal 100b, it determines whether there is a communication system/communication service provider mapped to a phone number of the second portable terminal 100b. If the controller 111 ascertains that there is a communication system/communication service provider mapped to a phone number of the second portable terminal 100b, it determines whether the communication system/communication service provider mapped to the second portable terminal 100b is the same as the communication system/communication service provider of the master SIM 109a. If the controller 111 ascertains that the communication system/communication service provider mapped to the second portable terminal 100b differs from the communication system/communication service provider of the master SIM 109a, it determines that a SIM switching process is required.

When a phone number storing mode is selected, the controller 111 controls the memory 107 to store phone numbers and information about communication system/communication service provider set to a portable terminal corresponding to a phone number.

In the following description, an exemplary communication method of a dual standby portable terminal is described.

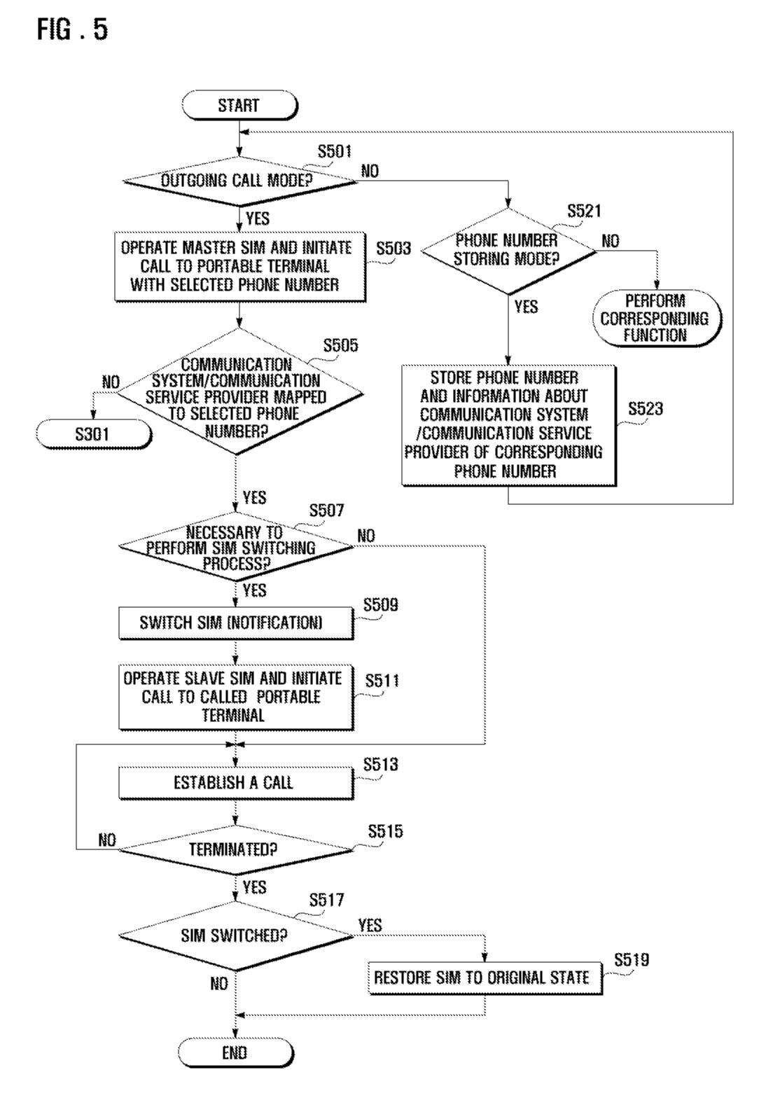

FIG. 5 is a flow chart describing a communication method of a dual standby portable terminal, according to an exemplary embodiment of the present invention.

Referring to FIG. 5, the controller 111 determines whether it is in an outgoing call mode in step S501. A user can select an outgoing call mode, to place a call, or a phone number storing mode for storing phone numbers.

If the controller 111 ascertains that it is in an outgoing call mode at step S501, it operates the master SIM 109a and initiates a call to the second portable terminal 100b in step S503. That is, the controller 111 of the first portable terminal 100a operates the master SIM 109a and initiates the call to the second portable terminal 100b through the first communication system/communication service provider 200a.

The controller 111 determines whether the communication system/communication service provider is mapped to the selected phone number in step S505. That is, the controller 111 determines whether the communication system/communications service provider mapped to a phone number of the second portable terminal 100b is stored. If the communication system/communications service provider mapped to a phone number of the second portable terminal 100b is not stored, the controller 111 performs the processes in FIG. 3. This refers to cases where a user initiates a call to a phone number that was not stored in the phone book of the memory 107 or when only a phone number is stored in the phone number, without information about an associated communication system/communication service provider.

If the communication system/communication service provider is mapped to a phone number of the second portable terminal 100b, the controller 111 determines whether a SIM switching process is required in step S507. The controller 111 determines whether the communication system/communication service provider of the second portable terminal 100b is the same as that of the master SIM 109a. If the communication system/communication service provider of the master SIM 109a differs from that mapped to the second portable terminal 100b, the controller 111 concludes that a SIM switching process is required. If it is determined that a SIM switching process is not required at step S507, the controller 111 proceeds to step S513. In another exemplary implementation of step S507, rather than only determining if the communication system/communication service provider of the second portable terminal 100b is the same as that of the master SIM 109a, the controller 111 may also determine if the communication system/communication service provider of the second portable terminal 100b is the same as that of the slave SIM 109b. In this case, if the controller determines that the communication system/communication service provider of the second portable terminal 100b differs from that of both the master SIM 109a and the slave SIM 109b, the controller may determine that it is not necessary to perform the SIM switching operation of step S509 and instead proceed to step S513.

If it is determined that a SIM switching process is required at step S507, the controller 111 performs a SIM switching process in step S509. The controller 111 performs a SIM switching process to operate the slave SIM 109b instead of the master SIM 109a that was operated when the call was initiated. The controller 111 controls the display unit 103 to display a pop-up message indicating that the SIM is switched to the slave SIM 109b. The controller 111 can also provide notification that a SIM switching process has been performed, through one or more of a sound, a vibration and a visual indicator.

After that, the controller 111 operates the slave SIM 109b and initiates the call to the second portable terminal 100b in step S511. The first and second portable terminals 100a and 100b establish a call therebetween in step S513.

The controller 111 determines whether a call is terminated in step S515. If the controller 111 ascertains that a call is terminated at step S515, in step S517 it determines whether a SIM switching process was previously performed. The controller 111 determines whether a SIM that was set when the original call was initiated was switched to another SIM during the call. That is, the controller 111 determines whether a SIM operated at step S503 is the same as the SIM operated at step S513. If the master SIM 109a is operated at step S503 and the slave SIM 109b is operated at step S513, the controller 111 restores the SIM to the original state in step S519. The controller 111 restores the master SIM 109a to the original state set when a call is initiated. If the controller 111 ascertains in step S517 that a SIM switching process was not previously performed, it terminates a corresponding function.

Referring again to step S501, if the controller 111 ascertains that it is not in an outgoing call mode, it determines whether it is in a phone number storing mode in step S521.

If the controller 111 ascertains that it is in a phone number storing mode at step S521, it receives a phone number and information about the communication system/communication service provider of a corresponding phone number and then stores them in the memory 107 in step S523. In the phone number storing mode, information about communication system/communication service providers, i.e., communication networks, is mapped to a corresponding phone number and then stored with the corresponding phone number. Alternatively, if the controller ascertains that it is not in the phone number storing mode at step S521, it performs a corresponding function.

Although exemplary embodiments of the present invention are implemented in such a way that the phone number of the second portable terminal is selected, the master SIM is operated by initiating a call, and the controller determines whether communication system/communication service provider of the SIM is the same as that of the second portable terminal, it should be understood that the present invention is not limited to the described examples. For example, it may be modified in such a way that, if the second portable terminal is selected, the controller determines whether the communication system/communication service provider of a corresponding portable terminal is the same as that of the SIM, and then the SIM switching process or the master SIM operation is performed. That is, before the master SIM is operated by an outgoing call, the SIM switching process or the master SIM operation can be performed only by selecting the second portable terminal.

As described above, exemplary embodiments of the present invention allow the first portable terminal to make a call with the second portable terminal through the same communication system or the same communication service provider's communication network, so that communication costs can be reduced. For example, since the dual standby portable terminals can make a call through the same communication service provider, it can obtain various discount advantages so that communication costs can be reduced.

While the invention has been shows and described with reference to certain exemplary embodiments thereof, it will be understood by those skilled in the art that various changes in form and details may be made therein without departing from the spirit and scope of the invention as defined by the appended claims and their equivalents.

What is claimed is:

1. A communication method of a dual standby portable terminal that can simultaneously connect with at least two communication networks, the method comprising:
operating a master Subscriber Identity Module (SIM);
initiating a call to a called portable terminal;
determining if a first SIM switching process is required;
switching the master SIM to a slave SIM if the first SIM switching process is required; and
operating the slave SIM and initiating the call with the called portable terminal.

2. The method of claim 1, wherein the determining if the first SIM switching process is required comprises determining if the master SIM supports a communication network of a SIM set in the called portable terminal.

3. The method of claim 2, wherein the switching of the master SIM to the slave SIM comprises:
determining a communication network of the called portable terminal in a first communication network server that performs communication through the master SIM;
requesting, by the first communication network server, a call from the called portable terminal;
establishing a call between the dual standby portable terminal and the called portable terminal if the communication network of the called portable terminal is the same as that of the first communication network server; and
transmitting a signal from the first communication network server to the called portable terminal, if the communication network of the called portable terminal is not the same as that of the first communication network server.

4. The method of claim 1, wherein the first SIM switching process is performed if a communication network set in the master SIM is not the same as that mapped to a phone number of the called portable terminal.

5. The method of claim 4, wherein the first SIM switching process is performed if a communication network set in the slave SIM is the same as that mapped to the phone number of the called portable terminal.

6. The method of claim 1, further comprising:
determining if a second SIM switching process is required;
switching the slave SIM to the master SIM if the second SIM switching process is required and establishing the call with the called portable terminal; and
establishing the call with the called portable terminal, if the second SIM switching process is not required.

7. The method of claim 1, further comprising:
determining, if a call is terminated, whether one of the master SIM and the slave SIM that was set when the call was initiated was switched to the other of the master SIM and the slave SIM during the call; and
restoring, if a SIM switching process is performed, the one of the master SIM and the slave SIM to the state set when the call was initiated.

8. The method of claim 1, wherein switching to the slave SIM comprises:
notifying that the master SIM is switched to the slave SIM.

9. The method of claim 8, wherein the notification comprises at least one of a pop-up message, a sound, a vibration, and a visual indication.

10. The method of claim 1, wherein the communication network is based on at least one of a communication system and a communication service provider.

11. A dual standby portable terminal, the terminal comprising:
two Subscriber Identity Modules (SIMs) for simultaneously connecting with at least two communication networks;
a first communication unit for operating a master SIM and making a call with a called portable terminal;
a second communication unit for operating a slave SIM and making a call with the called portable terminal; and
a controller for switching to the slave SIM if a first SIM switching process is required when the master SIM is operated and a call is initiated to the called portable terminal and for operating the slave SIM to make a call with the called portable terminal.

12. The terminal of claim 11, wherein the first SIM switching process is performed if a SIM operated when the call to the portable terminal is initiated does not support the same communication network of a SIM set in the called portable terminal.

13. The terminal of claim 11, wherein the first SIM switching process is performed in such a way that a first communication network server performing communication through the master SIM determines a communication network of the called portable terminal and transmits a signal to the called portable terminal if the communication network of the called portable terminal is not the same as that of the first communication network server.

14. The terminal of claim 11, wherein the first SIM switching process is performed if a communication network set in the master SIM is not the same as that mapped to a phone number of the called portable terminal.

15. The terminal of claim 14, wherein the first SIM switching process is performed if a communication network set in the slave SIM is the same as that mapped to the phone number of the called portable terminal.

16. The terminal of claim 11, further comprising:
a memory for storing phone numbers and information about communication networks mapped to the phone numbers.

17. The terminal of claim 11, wherein the controller determines if a second SIM switching process is required, switches from the slave SIM to the master SIM and establishes a call with the called portable terminal if the second SIM switching process is required, and establishes a call with the called portable terminal, if the second SIM switching process is not required.

18. The terminal of claim 11, wherein the controller determines, if a call is terminated, whether one of the master SIM and the slave SIM that was set when the call was initiated was switched to the other of the master SIM and slave SIM during the call, and restores, if a SIM switching process is performed the one of the master SIM and the slave SIM to the state set when the call was initiated.

19. The terminal of claim 11, wherein the controller notifies that the master SIM is switched to a slave SIM.

20. The terminal of claim 19, wherein the controller provides the notification through at least one of a pop-up message, a sound, a vibration, and a visual indication.

21. The terminal of claim 11, wherein the communication network is based on at least one of a communication system and a communication service provider.
